(19) United States
(12) Patent Application Publication
(10) Pub. No.: US 2026/0311909 A1
(43) Pub. Date: Oct. 8, 2026

(54) INSULATION FOR BUSBARS

(71) Applicant: BOND-LAMINATES GMBH, BRILON (DE)

(72) Inventors: Michael REIFFS, BRILON (DE); Gregor JASCHKEWITZ, BRILON (DE); Philipp GENDERS, BRILON (DE)

(21) Appl. No.: 19/482,664

(22) PCT Filed: May 6, 2024
(86) PCT No.: PCT/EP2024/062409

§ 371 Date: Nov. 7, 2025

(30) Foreign Application Priority Data
May 9, 2023 (EP) 23172197.8
Oct. 12, 2023 (EP) 23203345.6

(51) Int. Cl. H01B 3/47; H01B 7/08; H01M 50/505

(52) U.S. Cl. CPC H01B 3/47; H01B 7/08; H01M 50/505

(57) ABSTRACT

The present invention relates to a busbar insulation 10 for insulating a busbar 12, wherein the busbar insulation 10 comprises a composite material The composite material comprises a polymeric matrix material and a fibrous material disposed in the matrix material. The polymeric matrix comprises a thermoplastic polymer composition. The fibrous material is based on one or more non-flammable inorganic composition. The present invention further relates to a use a busbar insulation for insulating a busbar, a busbar provided with the busbar insulation and an energy system comprising the busbar.

The present invention relates to busbar insulation. The present invention further relates to a busbar provided with such insulation. Further, the present invention relates to an energy storage system comprising at least one such busbar.

In electrically driven vehicles, such as in purely electrically driven vehicles, hybrid vehicles or plug-in vehicles, high currents usually prevail. In particular, high currents flow between the high-voltage batteries of electric vehicles and the electric motors. Busbars, which are capable of conducting high currents, are usually provided for this purpose. Busbars must be safely insulated accordingly. The insulating materials used must ensure that the surrounding parts are shielded against the high voltage or electricity flowing through the busbar. Furthermore, the insulating properties must also be ensured for a fault case in which a high thermal load may occur.

CN 204190113 U describes an insulating foil for busbars, which is intended to increase the creepage distance between copper columns. In general, an insulating foil, a copper column and a busbar are provided. The insulating foil includes an edge seal and the busbar includes a gasket. The insulating foil is disposed on the surface of the busbar around the copper column.

CN 211670261 U describes a busbar insulation structure comprising: a busbar, the busbar comprising a plurality of busbar bodies; a first flame retardant insulating film, the busbar being installed on the first flame retardant insulating film; a second flame retardant insulating film, the second flame retardant insulating film being bonded to the first flame retardant insulating film such that the busbar is sandwiched between the first flame retardant insulating film and the second flame retardant insulating film.

CN 213844898 U discloses a busbar insulating device comprising an upper protective plate and a lower protective plate, wherein one side or two sides of the upper protective plate and the lower protective plate are provided with insulation fixing edges, the middle portion of the upper protective plate and the middle portion of the lower protective plate are provided with insulation seals, the insulation fixing edges are provided with insulation magnets, and the upper protective plate and the lower protective plate are connected to the insulation magnets by positioning devices.

CN 109215895 A describes a method for insulating a busbar. Such a method comprises coating a straight section of the busbar with an insulating film, such as a PET polyester film, sealing the structure thus produced, applying a sealing mass and drying the busbar.

CN 105957591 A describes an insulating coating for an irregular busbar. An insulation made of a polyurethane film is used for this purpose.

US 2019/237956 A1 describes a device for electrically connecting at least one electrical component to a first and a second busbar, the busbars having a different potential with respect to each other during electrical operation.

US 2020/0335238 A1 describes a thermally conductive electrical insulating nonwoven material, especially for improving heat dissipation from electrical transformers, motors, and generators. The material comprises inter alia organic fibers and a polymer matrix.

EP 2372723 A1 is concerned with the curing of electrical insulators, and particular with improving the curing of electrical insulators. The method comprises impregnating fibers with a UV-curable matrix.

RU 2501109C2 concerns an insulated composite power cable having a wire core defining a common longitudinal axis, a multiplicity of composite wires around the wire core, and an insulative sheath surrounding the composite wires. The composite wires can comprise inter alia an epoxy resin matrix and aramid fibers.

EP 3259762 B1 concerns an insulation element with low electrical conductivity for electrical isolation in the high voltage range, The isolation element comprises a natural fibrous material, preferably from wood and/or annual plants.

However, solutions according to the prior art still show potential for improvement.

It is the object of the present invention to overcome at least one disadvantage of the prior art at least in part. In particular, it is the object of the present invention to provide reliable insulation for busbars which can provide a secure insulation even under high thermal loads. Inventors surprisingly found that the present invention can advantageously provide a reliable insulation for busbars that can provide electrical insulation, and/or that can provide improved protection from electrical discharge events during and even following a thermal runaway event.

This object is solved at least in part by a busbar insulation having the features as disclosed herein. This object is further solved by a use having the features as disclosed herein, by a busbar having the features as disclosed herein, and by an energy storage system having the features as disclosed herein. Preferred embodiments of the invention are described in the dependent claims, in the description or in the figures, wherein further features described or shown in the dependent claims or in the description or in the figures may individually or in any combination constitute an object of the invention, unless the opposite clearly follows from the context.

Described is a busbar insulation for insulating a busbar, the busbar insulation comprising at least a composite material comprising a polymeric matrix material and a fibrous material disposed in the matrix material. Preferably, the fibrous material comprises, or essentially consists of, a compostion selected to, at least temporarily, withstand thermo-oxidative conditions during. As described in more detail herein below the polymeric matrix material is preferably, but not nessecarily, based on a thermoplastic composition. As an alternatie the matrix can material can at least partly or essentially be composed of a thermoset plastic compositon.

Such busbar insulation has significant advantages over prior art solutions.

The busbar insulation described is thus suitable for electrically insulating a busbar and is expediently arranged on or coated on the busbar for this purpose. A busbar is especially understood to encompass a component of this type that connects individual energy storage devices, for example battery cells or battery packs, to one another in an energy storage system or also connects energy storage devices to an electric motor, for example, in an energy storage system. In principle, such busbars are usually made of a metal, such as aluminum or copper. This enables good connectivity. Accordingly, the busbars must be electrically insulated. This insulation must ensure that the surrounding parts are shielded against the high voltage or electricity flowing through the busbar.

Especially in mobile applications, such as in an application in an electrically driven vehicle, for example motor vehicle, it is further important that the insulating properties of the busbar insulation are maintained at least for a certain period of time even in emergency situations, such as a car accident, battery failure or a fire, e.g. such a thermo-oxidative conditions, such as conditions during a thermal runaway.

In order to achieve this, it is provided in the busbar insulation described herein that it comprises a composite material, for example consisting thereof, which comprises a polymeric matrix material and a fibrous material arranged in the matrix material. The arrangement of the fibrous material in the matrix material may in principle be freely selectable depending on the specific application. Preferably, the fibrous material can be in the form of a textile, such as a woven fabric, a nonwoven fabric, a tape, or a scrim. This enables a defined alignment or three-dimensional structure of the fibrous material, so that good insulation can be ensured or at least improved even under fault conditions.

Typically, the fibrous material is based on, predominantly comprises, or even essentially consists of one or more non-flammable inorganic composition, preferably one or more of the inorganic composition as disclosed herein, As used herein, the phrasing ‘fibrous material that essentially consists of one or more inorganic composition’ may be understood as to refer to fibrous material that contains no more than 10 wt % of flammable constituents, preferably less, e.g. less than 5 wt % or even less than 1 wt %. Without wishing to be bound to theory inventors find that the higher the fraction of flammable/combustible constituents comprised within the fibrous material the less stable the insulation can be during progression of thermos oxidative degeneration of the polymer matrix and/or after a fire/thermal runaway event.

Accordingly, in the case of the busbar insulation described here, it becomes possible for it to retain its insulating properties, at least for a limited period of time, even after an unintentional incident such as an accident or fire. This can be the case in particular if, for example, a fire breaks out in a vehicle after an accident, which is potentially harmful to insulating materials, or also in the event of a battery failure or similar events such as a thermal runaway. The busbar insulation according to the invention can now also prevent, in the event of a fire, the insulation capacity or, in particular, the dielectric strength, from being lost due to exposure to increased temperatures as well as prevent a further directincrease of hazards emanating from the energy storage system.

According to the invention, it can be prevented, at least for a certain period of time, that, for example, occupants of a vehicle are directly exposed to a major hazard based on defective insulation of the busbars.

In this regard, the solution according to the present invention is particularly easy to implement, since the insulation is very simple in structure and is predominatly or essentially composed of the fibers and the matrix material.

In addition, particularly simple adaptability to the desired specific application can be made possible. The insulating capacity, i.e. in particular the dielectric strength (also resistane to electrical breakdown), or breakdown voltage, can be adjusted in a desired way by varying the structure of the busbar insulation or its insulating material, e.g. by varying the number, thickness and design of the fiber structure as well as the fibrous material in the insulating material.

The use of an appropriate fibrous material provides the advantage that no significantly higher demands have to be made on the plastic of the matrix material. Even if the matrix material were to lose at least some of its insulating properties after a short time, the insulating properties of the insulating material can be retained by the fibrous material even after prolonged exposure to high temperatures. This can usually withstand the conditions that also occur during a fire much better than is possible with a plastic as the matrix material.

Accordingly, it is particularly preferred for solving the object of the resistance of the insulating behavior, i.e. in particular the breakdown voltage, is based at least in part on the properties of the material of the fibers or the fibrous structure.

Particularly preferably, the insulating properties, i.e. in particular the electric breakdown voltage, of the busbar insulation can be maintained at a value of at least 700 V DC, for a period of at least 5 minutes, for example at least 10 minutes, at a temperature of at least 450° C., for example at least 500° C., for example at least 1000° C. The breakdown voltage can be determined according to DIN EN 60243.

In principle, it is advantageous if the fibers are formed from an electrically insulating material, prefreably an electrically insulating and non-flammable material. It may be further preferred if the fibrous material has a fiber length in a range of ≥10 mm. In this embodiment, the fibers may preferably include so-called continuous fibers. Continuous fiber also referred to as endless fiber as such is known in the art and is herein understood to have an aspect ratio of at least 500. For example, the endless fiber in the insulating may have a length extending along of a lateral dimension of the busbar insulation it is comprised in. In particular, fibers in this embodiment can allow a stable fiber structure to remain, which in an extreme case can also serve as an insulating material without the matrix material, even in the event of damage or, in principle, in the event of a heat effect on the insulating material. In particular according to this embodiment, a particularly reliable insulating capacity can be ensured even under prolonged exposure to high temperatures, even if the matrix material cannot withstand these conditions.

In addition, it may preferably be possible, particularly when using such fibers, to provide the fibers as a textile, for example as a woven fabric, nonwoven fabric, tape, or scrim or a laid up fabric, which can further enhance the above-mentioned properties. In this way, a precisely defined three-dimensional structure is provided, which surrounds the busbar and can thus provide sufficient insulation together with the matrix material or air present.

The matrix material can comprise a thermosetting or thermoplastic plastic composition. In particular, such plastics can have good insulating properties and can furthermore be easily processed, so that an insulating material according to the invention can advantageously also be produced as insulation for busbars. Particularly preferred, the plastic of the matrix material can be a thermoplastic. As compared to thermosetting based matrix materials thermoplastics can advantageously provide one or more of: comparatively easy application onto and/or around a busbar; and recyclability.

The insulating composite material can generally be identified as having a resistivity higher than 10¹² (Ohm*mm²)/m. The higher the better the electrical insulating characteristics per unit thickness of the busbar insulation can be. The fibers as employed within the composite preferably have a higher resistivity. Preferably in the range of 10¹⁵-10²¹ Ohm*mm²)/m, for example 10¹⁶-10²⁰ (Ohm*mm²)/m, such as glass fibers. Other fiber materials which are within this scope include other mineral fibers like ceramic fibers and/or basalt fibers.

With regard to the layup, it can be advantageous that the composite material, i.e. the actual insulating material of the busbar insulation, has at least one core layer with fibrous material, which is surrounded by end layers with fiber-free matrix material. Thus, a multilayer structure is provided, which internally comprises a core layer having fibrous material arranged in the matrix material and, for example, completely in contact with the matrix material. Along the multilayer structure, this is preferably surrounded on both sides by pure, i.e. fiber-free, matrix material of the end layers, thereby forming a sandwich structure. In this way, the insulating properties described can be combined in a particularly preferred manner with applicability as insulation and, in particular, processability for this purpose. In principle, however, a multilayer structure is also possible in which more than one core layer is present with optional layers of pure matrix material in between.

With regard to the matrix material, and in this respect in particular in order to combine good processability with good insulation properties, it is preferred that the matrix material comprises a thermoplastic polymer, the thermoplastic being selected from the group consisting of polyamide, in particular polyamide 6 (PA6), polyamide 66 (PA66), polyamide 12 (PA12), polyamide 46 (PA46), polyamide 1010 (PA10.10), polyamide 11 (PA11), polyolefins, in particular polyethylene (PE), polypropylene (PP), polyphenylene sulfide (PPS), thermoplastic polyurethane (TPU), polyphthalamide (PPA), polybutylene terephthalate (PBT), polyethylene terephthalate (PET), polycarbonate (PC), polyetherimide (PEI), polyetheretherketone (PEEK), polystyrene (PS), styrene-acrylonitrile copolymer (SAN), acrylonitrile-butadiene-styrene copolymer (ABS), polysulfone (PSU), polylactic acid (PLA). Regarding a thermoset material, for example, an epoxy resin can be used.

With regard to the fibrous material, i.e. the material from which the fibers are made, it may be preferred that the fiber material is selected from the list consisting of glass, aramid, basalt, natural fibers or mixtures thereof. Such fibers have good electrical insulation properties and can also usually be easily processed in the form of a woven, nonwoven, tape, scrim or laid fabrics such as multilayer fabric sheets.

With regard to combined benefits as to electrical insulation properties, ease of processing, and mitigating electrical discharge one or more of: mineral fibers including ceramic fibers, glass-based fibers, and/or basalt-based fibers; or combinations thereof, are particularly preferred. Glass and basalt have been demonstrated as exemplary suitable non-flammable materials enabling good electrically insulating properties during normal operation in combination with mitigating loss or reduction of protection against electrical discharge, during thermos-oxidative conditions, such as a thermal runaway In a preferred embodiment, the fibrous material may comprise continuous fiber textiles, i.e. fibers with a length of ≥10 mm, as woven fabric, nonwoven fabric, tape or scrim based on at least one raw material selected from the list consisting of glass, aramid, basalt, natural fibers or mixtures thereof, and the matrix material may comprise a thermoplastic selected from the list consisting of polyamide, in particular polyamide 6 (PA6), polyamide 66 (PA66), polyamide 12 (PA12), polyamide 46 (PA46), polyamide 1010 (PA10.10), polyamide 11 (PA11), polyolefins, in particular polyethylene (PE), polypropylene (PP), polyphenylene sulfide (PPS), thermoplastic polyurethane (TPU), polyphthalamide (PPA), polybutylene terephthalate (PBT), polyethylene terephthalate (PET), polycarbonate (PC), polyetherimide (PEI), polyetheretherketone (PEEK), polystyrene (PS), styrene-acrylonitrile copolymer (SAN), acrylonitrile-butadiene-styrene copolymer (ABS), polysulfone (PSU), polylactic acid (PLA). In line with the description above the continuous fiber textile is preferably based on one or more raw material selected from the list consisting of glass and basalt.

With regard to the proportion of fibers, it may be of particular advantage for the described properties that the fibrous material is present in the insulating material in a proportion of ≥30 vol.-% to ≤90 vol.-%, these proportions referring to the entire composite material. Preferably, the proportion of fibers may range from ≥40 vol.-% to ≤50 vol.-%, such as ≥43 vol.-% to ≤48 vol.-%. Such fiber volume fractions allow good dielectric strength even after prolonged exposure to heat to be advantageously combined with good mechanical processability.

It will be appreciated that the busbar insulation as disclosed herein can advantageously be manufactured as a construction element, e.g. independent from a busbar. The busbar insulation as disclosed can, for example, be in the form of a planar sheet material. The busbar insulation can advantageously be applied to a insulate busbar at a separate application step. For example, in an application process comprising one or more of resizing the material to match a dimension of a busbar or portion thereof which is to be insulated, and applying the insulation product onto said busbar or portion. Sizing, respectively application, can advantageously be performed using conventional procedures known in the art including but not limited to cutting, respectively thermoforming.

With respect to further advantages and technical features of the busbar insulation, reference is hereby made to the description of the use, the busbar, the energy storage system, the figures and the description of the figures, and vice versa.

Also described is a use of a busbar insulation for insulating a busbar, wherein the busbar insulation is formed as described above.

It has been shown that the insulation described, or its insulating material, has very good properties, especially for insulating a busbar. Specific applications include the insulation of busbars in energy storage systems, especially in mobile applications such as motor vehicles.

In particular, good processability can be combined with a high electrical insulation quality. In particular, the insulation quality is maintained even after prolonged exposure to high temperatures. Thus, according to the invention, it is possible that the insulating properties are maintained after a thermal load of at least 450° C. for at least 5 min and the insulating properties are quantified via an electrical breakdown voltage and have a value of at least 700 V DC, in particular measured according to DIN EN 60243.

This enables the safety behavior to be improved even in the event of a fault, such as an accident, and the associated generation of heat, for example in the event of a fire.

With respect to further advantages and technical features of use, reference is hereby made to the description of the busbar insulation, the busbar, the energy storage system, the figures and the description of the figures, and vice versa.

Also described is a busbar for connecting an energy storage device to a further energy storage device or to an electric motor, the busbar being provided with busbar insulation for electrically insulating the busbar. The busbar insulation is designed as described above.

In particular, the busbar can be part of an energy storage system and can be used in mobile applications such as motor vehicles.

Such a busbar offers particularly the advantages as described above. In summary, the safety behavior can also be improved in the event of a fault, such as an accident, and the associated development of heat, for example in the event of a fire.

Such a busbar provided with busbar insulation can be produced, for example, by placing the busbar in a forming die and coating it with the busbar insulation material of the busbar insulation by forming the insulation material and thus applying the insulation material to the busbar and producing the busbar insulation.

With respect to further advantages and technical features of the busbar, reference is hereby made to the description of the use, busbar insulation, energy storage system, figures and description of figures, and vice versa.

Also described is an energy storage system comprising at least one energy storage device for supplying an electric motor with electrical energy, the energy storage system comprises at least one busbar for electrically connecting the energy storage device to a further energy storage device or to the electric motor. The busbar is designed as described above.

In particular, the energy storage device can be part of an energy storage system and can be used in mobile applications, such as motor vehicles.

In the case of the energy storage system, in particular the advantages described above arise. In summary, the safety behavior can also be improved in the event of a fault, such as an accident, and associated heat generation, for example in the event of a fire.

With respect to other advantages and technical features of the energy storage system, reference is hereby made to the description of use, busbar insulation, the busbar, the figures and description of figures, and vice versa.

The following is an exemplary explanation of the invention with reference to the accompanying figures and examples, wherein the features set forth below may each individually or in combination constitute an aspect of the invention, and wherein the invention is not limited to the following figures, description, and following embodiment. The following is shown:

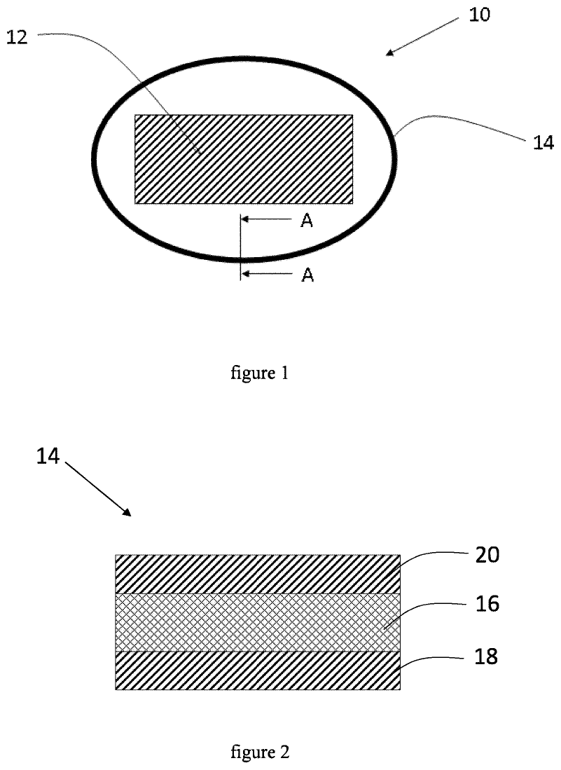

FIG. 1 shows a schematic view of a busbar coated with an insulating material; and

FIG. 2 shows a view of the insulating material along view A-A defined in FIG. 1.

FIG. 1 shows a busbar 12 being insulated with an insulating material 14. On the busbar 12, the insulating material 14 thus forms a busbar insulation 10. This busbar 12 may, for example, be part of an energy storage system, wherein the busbar 12 serves to connect an energy storage device to another energy storage device or to an electric motor. The energy storage device or devices are then used to supply electrical energy to an electric motor.

A cross-section through the insulating material 14 or through the busbar insulation 10 according to view A-A as shown in FIG. 1 is shown in FIG. 2.

The insulating material 14 comprises a composite material comprising a polymeric matrix material and a fibrous material arranged in the matrix material such that the busbar insulation 10 preferably has an electrical breakdown voltage or dielectric strength of at least 700 V DC and wherein the insulating material 14 is formed such that the breakdown voltage or dielectric strength of the busbar insulation 10 is present even after a thermal load of at least 450° C. for at least 5 minutes. As shown in FIG. 2, the composite material has at least one core layer 16 comprising fibrous material surrounded by end layers 18, 20 comprising fiber-free matrix material.

Such a layered structure can have a thickness in a range of ≥0.2 mm to ≤5 mm, for example from ≥0.9 mm to ≤3 mm, such as from ≥1.2 mm to ≤2 mm. The individual layers or plies may each have a corresponding thickness.

In general and irrespective of the specific embodiment, a plurality of layers can also be provided. For example, a plurality of core layers 16 can be provided, each of which is separated by fiber-free layers of matrix material, with the core layers 16 in turn being surrounded on the outside by end layers 18, 20.

With regard to the matrix material, it may be provided that it comprises a plastic, the plastic being selected from the group consisting of polyamide, in particular polyamide 6 (PA6), polyamide 66 (PA66), polyamide 12 (PA12), polyamide 46 (PA46), polyamide 1010 (PA10.10), polyamide 11 (PA11), polyolefins, in particular polyethylene (PE), polypropylene (PP), polyphenylene sulfide (PPS), thermoplastic polyurethane (TPU), polyphthalamide (PPA), polybutylene terephthalate (PBT), polyethylene terephthalate (PET), polycarbonate (PC), polyetherimide (PEI), polyetheretherketone (PEEK), polystyrene (PS), styrene-acrylonitrile copolymer (SAN), acrylonitrile-butadiene-styrene copolymer (ABS), polysulfone (PSU), polylactic acid (PLA).

The fibers may have a fiber length in a range of about ≥10 mm, wherein the fibers are in a structure selected from a woven, nonwoven, tape, scrim or laid fabric. Alternatively or additionally, it may be advantageous for the fibrous material to be selected from glass, aramid, basalt, natural fibers, or mixtures thereof. Most preferred in terms of maintaining advantageous breakdown- or dielectric-properties of the busbar insulation even after a thermal load of at least 450° C. for at least 5 minutes are fibers that are based on one or more electrically insulating, non-flammable composition as disclosed herein. Particularly preferably, the fibers may be present in the matrix material in a fiber volume fraction of ≥30 vol.-% to ≤90 vol.-%, based on the total insulating material.

In a specific embodiment, the fibrous material may comprise fibers having a length of ≥10 mm as woven fabric, nonwoven fabric, tape, scrim, or laid fabric based on at least one raw material selected from the list consisting of glass, aramid, basalt, natural fibers or mixtures thereof, and the matrix material may comprise a thermoplastic selected from the list consisting of polyamide, in particular polyamide 6(PA6), polyamide 66 (PA66), polyamide 12 (PA12), polyamide 46 (PA46), polyamide 1010 (PA10.10), polyamide 11 (PA11), polyolefins, in particular polyethylene (PE), polypropylene (PP), polyphenylene sulfide (PPS), thermoplastic polyurethane (TPU), polyphthalamide (PPA), polybutylene terephthalate (PBT), polyethylene terephthalate (PET), polycarbonate (PC), polyetherimide (PEI), polyetheretherketone (PEEK), polystyrene (PS), styrene-acrylonitrile copolymer (SAN), acrylonitrile-butadiene-styrene copolymer (ABS), polysulfone (PSU), polylactic acid (PLA). In line with the description above the continuous fiber textile is preferably based on one or more raw material selected from the list consisting of glass and basalt.

The use of a fiber-enclosing plastic composite material for insulating a busbar has the great advantage that, even in the event of a failure or fire and even in the case of damage of the matrix, the existing fibers serve as spacers and thus insulators and remain around the busbar. As a result, the insulation behavior can be further ensured even by the air thus present.

### Examples

The positive effects of a busbar insulation 10 according to the invention is shown in the following examples for determining the dielectric strength performace (also referred to as resistance to electrical breackdown) of composite materials which can form a busbar insulation 10 according to the invention.

A flat, 20 mm thick aluminum plate served as the ground electrode. The high voltage electrode consisted of a flat turned and polished, 80×80 mm² big Aluminum profile with rounded edges. The high voltage was supplied by means of a transformer and one way rectification with 25 nF mesh capacitance. Five identical test specimens were tested accordingly.

With regard to the test specimens, these consisted of a matrix of polyamide 6 with glass fiber fabrics embedded in it in a fiber volume ratio of 47% or of pure glass fiber fabrics.

First test specimens were formed as a plate of a plastic-fiber composite material with a thickness of 1 mm and a size of 310 mm×320 mm. At a voltage of 30 kV DC for 60 seconds, no flashover or electrical breakdown was observed.

Second test specimens were formed as a plate of a plastic-fiber composite material with a thickness of 1 mm and a size of 150 mm×150 mm. At a voltage of 20 kV DC for 60 seconds, there was no flashover or electrical breakdown.

Third test specimens were formed only from fabric mats of the fibrous material. These were provided in two layers and were tested in a size of 150 mm×150 mm. No flashover was observed at a voltage of 3 kV DC for 60 seconds.

Fourth test specimens were formed only from a single-layer fabric mat of the fibrous material. These were tested at a size of 150 mm×150 mm. At a voltage of 1.9kV DC for 60 seconds, no flashover was recorded for four test specimens, and for one test specimen, a breakdown was only recorded after 40 seconds.

In order to test the temperature resistance of the insulating properties, the dielectric strength of a single-layer mat or a single-layer tape (mat) with a thickness of 1 mm was tested after storage for 5 minutes at 500° C.. No breakdown was determined at less than 3.9 kv. For corresponding mats with a total thickness of 3 mm, no breakdown at less than 9.5 kV could be determined.

Inventors find that for similar specimen but without fibrous material disposed in the plastic matrix, or for similar specimen but with organic fibers the mentioned benefits in preventing electric breakdown will reduced or absent. Without, wishing to be bound by theory, compoarively poor perforamce of orgaqnic fibers with respect to mineral/inroganic fibers. For example, for aramide inventeors find a degradation starting from about 400° C., whereas other polymer fiber strctures tend to degrade/melt. Earlier.

### REFERENCE SIGNS

10 Busbar insulation
12 Busbar
14 Insulating material
16 Core layer
18 end layer
20 end layer

1. A busbar insulation for insulating a busbar, wherein the busbar insulation comprises a composite material, which comprises a polymeric matrix material and a fibrous material disposed in the matrix material, wherein polymeric matrix comprises a thermoplastic polymer composition, and wherein the fibrous material is based on one or more non-flammable inorganic composition.

2. The busbar insulation according to claim 1, wherein the busbar insulation has an electrical breakdown voltage of at least 700V DC, and in that the breakdown voltage after a thermal load of at least 450° C. for at least 5 min is in the range defined above.

3. The busbar insulation according to claim 1, wherein the fibrous material has a fiber length in a range of ≥10 mm.

4. The busbar insulation according to claim 1, wherein the fibers are in a structure selected from a woven, nonwoven, tape, or scrim.

5. The busbar insulation according to claim 1, wherein the fibrous material is based on a raw material selected from a list consisting of: glass; basalt; or mixed forms thereof.

6. The busbar insulation according to claim 1, wherein the matrix material is selected from a thermoplastic.

7. The busbar insulation according to claim 1, wherein the matrix material comprises a plastic, the plastic being selected from a group consisting of: polyamide, in particular polyamide 6 (PA6), polyamide 66 (PA66), polyamide 12 (PA12), polyamide 46 (PA46), polyamide 1010 (PA10.10), polyamide 11 (PA11); polyolefins, in particular polyethylene (PE), polypropylene (PP); polyphenylene sulfide (PPS); thermoplastic polyurethane (TPU); polyphthalamide (PPA); polybutylene terephthalate (PBT); polyethylene terephthalate (PET); polycarbonate (PC); polyetherimide (PEI); polyetheretherketone (PEEK); polystyrene (PS); styrene-acrylonitrile copolymer (SAN); acrylonitrile-butadiene-styrene copolymer (ABS); polysulfone (PSU); polylactic acid (PLA).

8. The busbar insulation according to claim 1, wherein the composite material comprises at least one core layer comprising fibrous material, the core layer being layered between end layers comprising fiber-free matrix material.

9. The busbar insulation according to claim 1, wherein the fibrous material comprises fibers having a length of ≥10 mm as woven fabric, nonwoven fabric, tape, scrim or laid up fabric based on at least one raw material selected from a group consisting of glass, basalt, or mixed forms thereof, and wherein the matrix material comprises a thermoplastic selected from a group consisting of: polyamide, in particular polyamide 6 (PA6), polyamide 66 (PA66), polyamide 12 (PA12), polyamide 46 (PA46), polyamide 1010 (PA10.10), polyamide 11 (PA11); polyolefins, in particular polyethylene (PE), polypropylene (PP); polyphenylene sulfide (PPS); thermoplastic polyurethane (TPU); polyphthalamide (PPA); polybutylene terephthalate (PBT); polyethylene terephthalate (PET); polycarbonate (PC); polyetherimide (PEI); polyetheretherketone (PEEK), polystyrene (PS); styrene-acrylonitrile copolymer (SAN); acrylonitrile-butadiene-styrene copolymer (ABS); polysulfone (PSU); polylactic acid (PLA).

10. The busbar insulation according to claim 1, wherein the fibrous material is present in the matrix material in an amount of ≥30 vol.-% to ≤90 vol.-%, based on the composite material.

11. A use of a busbar insulation for insulating a busbar, wherein the busbar insulation is formed according to claim 1.

12. A busbar for connecting an energy storage device to a further energy storage device or to an electric motor, the busbar being provided with a busbar insulation for electrically insulating the busbar (12), wherein the busbar insulation is designed according to claim 1.

13. Energy storage system comprising at least one energy storage device for supplying an electric motor with electrical energy, wherein the energy storage system comprises at least one busbar for electrically connecting the energy storage device with a further energy storage device or with the electric motor, wherein the busbar is arranged according to claim 12.
